(19) United States
(12) Patent Application Publication
(10) Pub. No.: US 2026/0092236 A1
(43) Pub. Date: Apr. 2, 2026

(54) LIQUID HAND DISHWASHING DETERGENT COMPOSITION

(71) Applicant: The Procter & Gamble Company, Cincinnati, OH (US)

(72) Inventors: Sophia EBERT, Mannheim (DE); Frank HUELSKOETTER, Birkenheide (DE); Joerg NIEBERLE, Wachenheim (DE); Pieter Jan Maria SAVEYN, Heusden (BE); Gang SI, Newcastle upon Tyne (GB); Evelyne Johanna Lutgarde VAN HECKE, Deinze (BE)

(21) Appl. No.: 19/233,191

(22) Filed: Jun. 10, 2025

(30) Foreign Application Priority Data
Sep. 27, 2024 (EP) 24203165.6

(51) Int. Cl. C11D 1/94; C11D 1/29; C11D 1/722

(52) U.S. Cl. CPC C11D 1/94; C11D 1/29; C11D 1/722

(57) ABSTRACT

The need for a dishwashing detergent composition which provides effective grease cleaning, and suds mileage in the presence of greasy soil, while also using cleaning ingredients having improved biodegradability, is met by formulating the detergent composition with a surfactant system comprising anionic surfactant and a diamine alkoxylate having a weight average molecular weight (Mw) in the range of from 1,200 to 3,200 g/mol, and a propylene oxide content which is between 65% to 95% by weight in relation to the total weight of the diamine alkoxylate.

### FIELD OF THE INVENTION

The invention relates to liquid hand dishwashing detergent compositions.

### BACKGROUND OF THE INVENTION

Hand dishwashing detergents are widely used in households to clean dishes, utensils, and cookware. These detergents typically contain a combination of surfactants, solvents, builders, and polymers to facilitate grease removal and overall cleaning performance. However, many of the better performing ingredients, and especially cleaning polymers, are not biodegradable, or are relatively slowly biodegradable.

There is a growing demand for more environmentally friendly hand dishwashing detergent compositions with improved biodegradability. After use, the detergent compositions typically enter the household wastewater stream. While cleaning polymers improve the efficacy of grease removal, many can also take a long time to biodegrade in the waste-water stream.

Various attempts have been made to incorporate more biodegradable materials into detergent compositions. However, achieving a balance between enhanced biodegradability and effective cleaning, especially grease cleaning, remains a challenge.

Hence, a need remains for a dishwashing detergent composition which provides effective grease cleaning, and suds mileage in the presence of greasy soil, while also using cleaning ingredients having improved biodegradability.

Alvarez-Lorenzo et al. (Alvarez-Lorenzo, C. et al.; 2010; Front Biosci (Elite Ed); 1; 2(2): 424-40; doi: 10.2741/e102) disclose alkoxylated diamines, namely the Tetronic® series of BASF. These alkoxylates are X-shaped amphiphilic block copolymers formed by four arms of poly (ethylene oxide)-poly (propylene oxide) (PEO-PPO) blocks bonded to a central ethylenediamine moiety. In contrast to the alkoxylates of use in the present invention, the disclosed polymers have higher molecular weight (Mw) that is at least 3600 g/mol or have a propylene oxide content that is smaller than 80% by weight in relation to the total weight of the diamine alkoxylate. Whereas the present invention is directed towards liquid hand dishwashing detergent compositions, the polymers described by Alvarez-Lorenzo et al. are used to support drug delivery. The skilled person would expect that the polymers of Alvarez-Lorenzo et al. possessing a molecular weight (Mw) over 3200 g/mol are not significantly biodegradable and that the polymers which have a propylene oxide content that is smaller than 80% by weight in relation to the total weight of the diamine alkoxylate do not demonstrate significant wash performance.

### SUMMARY OF THE INVENTION

The present invention relates to a liquid hand dishwashing detergent composition comprising: from 5% to 50% by weight of the composition of a surfactant system, wherein the surfactant system comprises anionic surfactant; and diamine alkoxylate, wherein: at least one of the NH-functionalities of the diamine is modified to form a polyalkylene oxide branch; each of the at least one polyalkylene oxide branches comprises ethylene oxide (EO) and propylene oxide (PO); the weight average molecular weight (Mw) of the diamine alkoxylate is in the range of from 1,200 g/mol to 3,200 g/mol; and the propylene oxide content is between 65% to 95% by weight in relation to the total weight of the diamine alkoxylate.

### DETAILED DESCRIPTION OF THE INVENTION

Formulating liquid hand dishwashing detergent compositions to comprise a diamine alkoxylate, as described herein, provides a composition having improved biodegradability, while also proving improved greasy soil removal and suds mileage.

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present invention can comprise, consist of, and consist essentially of the essential elements and limitations of the invention described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease in the material) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of the composition relating to suds character during the dishwashing process. The term “sudsing profile” of the composition includes initial suds volume generated upon dissolving and agitation, typically manual agitation, of the composition in the aqueous washing solution, and the retention of the suds during the dishwashing process. Preferably, hand dishwashing compositions characterized as having “good sudsing profile” tend to have high initial suds volume and/or sustained suds volume, particularly during a substantial portion of or for the entire manual dishwashing process. This is important as the consumer uses high suds as an indicator that enough composition has been dosed. Moreover, the consumer also uses the sustained suds volume as an indicator that enough active cleaning ingredients (e.g., surfactants) are present, even towards the end of the dishwashing process. The consumer usually renews the washing solution when the sudsing subsides. Thus, a low sudsing composition will tend to be replaced by the consumer more frequently than is necessary because of the low sudsing level.

“Easy rinsing” or “an easy rinsing profile” means that the foam generated during the main wash cycle can be rinsed faster and less water can be used to collapse the foam from the main wash cycle. Faster collapsing of the foam is preferred to reduce the amount of time spent rinsing and overall washing time, as well. Reducing the amount of water used to collapse the foam is preferred because it aids in water conservation.

It is understood that the test methods that are disclosed in the Test Methods Section of the present application must be used to determine the respective values of the parameters of Applicants' inventions as described and claimed herein.

All percentages are by weight of the total composition, as evident by the context, unless specifically stated otherwise. All ratios are weight ratios, unless specifically stated otherwise, and all measurements are made at 25° C., unless otherwise designated.

### Liquid Hand Dishwashing Detergent Composition

The composition is a liquid composition, which is a liquid hand dishwashing composition, and hence is in liquid form. The liquid hand dishwashing composition is preferably an aqueous composition. As such, the composition can comprise from 50% to 85%, preferably from 50% to 75%, by weight of the total composition of water.

The composition may have a pH greater than or equal to 6.0, or a pH of from 6.0 to 12.0, preferably from 7.0 to 11.0, more preferably from 7.5 to 10.0, measured as a 10% aqueous solution in demineralized water at 20° C.

The composition of the present invention can be Newtonian or non-Newtonian, preferably Newtonian, over the usage shear rate range which is typically from 0.1 s⁻¹ to 100 s⁻¹. Preferably, when Newtonian, the composition has a viscosity of from 10 mPa·s to 10,000 mPa·s, preferably from 100 mPa·s to 5,000 mPa·s, more preferably from 300 mPa·s to 2,000 mPa·s, or most preferably from 500 mPa·s to 1,500 mPa·s, alternatively combinations thereof, over the typical usage shear rate range, measured following the test method described herein.

### Diamine Alkoxylate

The liquid hand dishwashing detergent composition comprises at least one diamine alkoxylate. For sake of clarity, the term “diamine alkoxylate” refers to compounds that are derived from diamines, herein called the “diamine core”, but do not necessarily possess any non-modified amine groups. The diamine alkoxylate can be present at a level of from 0.05% to 5.0%, more preferably from 0.1% to 3.5%, most preferably from 0.3% to 2.5% by weight of the composition.

In the diamine alkoxylate:
i. at least one of the NH-functionalities of the diamine is modified to form a polyalkylene oxide branch;
ii. each of the at least one polyalkylene oxide branches comprises ethylene oxide (EO) and propylene oxide (PO);
iii. the weight average molecular weight (Mw) of the diamine alkoxylate is in the range of from 1,200 g/mol to 3,200 g/mol; and
iv. the propylene oxide content is between 65% to 95% by weight in relation to the total weight of the diamine alkoxylate.

Within the context of the diamine alkoxylates of use in the present invention, the term “NH-functionality” is defined as follows: A primary amine group (—NH₂) has two NH-functionalities, a secondary amine group only one NH-functionality, and a tertiary amine group, by consequence, has no reactive NH-functionality. Thus, before being modified a diamine possessing two primary amine groups has four NH-functionalities.

The diamine alkoxylate of use in the invention comprise side chains, (poly)alkylene oxide branches, which are directly attached to the nitrogen atom of the NH-functionality of the diamine. The side chains are preferably (solely) made up from ethylene oxides and propylene oxides. Typically, a side chain possesses on average 6 to 20, preferably 7 to 13 AO units. Usually, the used AO units are equally distributed among the different branches including a modest statistical variation. More detailed embodiments describing the different chain lengths are provided below.

It is noted that all such numbers are numbers “on average” meaning that such numbers refer to the average number for such unit per NH-functionality calculated based on all NH-functionalities of the diamine alkoxylate.

It is to be emphasized that the reactions leading to the inventive compounds are statistical reactions, meaning there is never just one chemically exactly defined compound present, but an diamine alkoxylate of use in the present invention always is a mixture of slightly deviating structures, all stemming from the same reaction within one reaction space; the difference of those structures clearly stemming from the facts that no reaction proceeds in exactly the same way and the same speed on all functional units, especially as the chemical reactivities of the functional units—here mainly those of the —NH groups, differs according to their environment, meaning that a primary amine group reacts differently than a secondary amine, and also the chemical environment of the groups may be different; this leads in an overall view to slightly deviating structures being present, and thus any diamine alkoxylate of use in this invention being defined and described herein, never is just one chemical compound, but always a mixture of slightly deviating compounds, having a statistical distribution. As the reactivities of those groups are not differing by a large extent, the deviation is relatively small. Hence, defining an diamine alkoxylate of use in the invention by a prototypical member is a viable way of defining the structure. Also, defining the composition of the side chains by average numbers (including those variables defined in the present and following embodiments based on the numbers of NH-functionalities being present in the diamine alkoxylates is a useful way of defining the overall composition of any mixture herein defined as “an diamine alkoxylate of use in the invention”.

Therefore, unless otherwise indicated, the values, ranges and ratios given in the specification for the number of NH-functionalities, weight-average molecular weight (Mw) and the number-average molecular weight (Mn) relate to the average values in heterogenic mixture of the synthesized diamine alkoxylates containing individual, slightly from each other deviating chemical structures that result from the preparation method used. As known in polymer science, the polydispersity (weight-average molecular weight (Mw)/number-average molecular weight (Mn)) is then a measure for the (in) homogeneity within the mixture of different species in “the diamine alkoxylates”.

The term “average number of AOs (EOs and/or POs) per polyalkylene oxide branch”, as used herein, refers to the calculated number of AO units that should be present in one polyalkylene oxide branch. As explained in more detail above, the skilled person is well-aware of the fact that the synthesis of the inventive compounds will result in a mixture of slightly deviating compounds underlying a statistical distribution. Thus, the “average number of AOs per polyalkylene oxide branch” is calculated by dividing the total amount of employed mol AO (EO+PO) per mol of diamine by the number of NH-functionalities of diamine.

The terms “essentially consisting of” or “consisting essentially of”, as used interchangeably herein, with respect to the diamine or diamine alkoxylate means that compound may comprise impurities or other types of compounds in an amount up to not more than 10% w/w, not more than 7.0% w/w, not more than 5.0% w/w, not more than 3.0% w/w, not more than 2.0% w/w, not more than 1.0% w/w, not more than 0.5% w/w or not more than 0.1% w/w.

It is noted that the alkylene oxide used to prepare the inventive compounds may be derived from a fossil or non-fossil carbon source or even a mixture of the before mentioned. Preferably, the amount of non-fossil carbon atoms in the alkoxy side chains is at least 10%, at least 20%, at least 40%, at least 70%, at least 95% or it solely comprises non-fossil derived carbon atoms. The skilled person is well-aware of commercial alkylene oxide products made of non-fossil carbon sources (these products are often sold as being sustainable, renewable or bio-based). For example, methods to prepare bio-based propylene oxide are known (see Abraham, D. S., “Production of propylene oxide from propylene glycol” Master's Thesis University of Missouri-Columbia (2007) (75 pages)).

In a similar way the skilled person is aware of diamines that are based on non-fossil carbon atoms. In preferred diamine alkoxylates, at least 10%, at least 20%, at least 40%, at least 70%, at least 95% or even 100% of the carbon atoms in the diamine are non-fossil derived carbon atoms. For example, 1,4-diaminobutane (BDA) is widely produced on industrial scale by means of biotechnological processes from renewable feedstock (i.e. plants) (Li, Z. et al., 2018, J. Ind. Microbiol. Biotech., 45 (2), pp. 123-139) or through microbiological pathways (Qian, Z. G. et al., 2009, Biotech. Bioeng., 104 (4), pp. 651-662).

Preferably, the propylene oxide content is between 70% to 95%, preferably between 80% to 95% by weight, more preferably from 85% to 90% in relation to the total weight of the diamine alkoxylate.

The diamine used to form the diamine alkoxylate (that is, the diamine core) typically has two amine groups, and can have from one NH-functionality to four NH-functionalities. Preferably, the diamine has two primary amine groups (which corresponds to four NH-functionalities). The term “primary amine group”, as used herein, refers to the following chemical group:—NH₂, wherein the dash indicates the bond to the remaining part of the amine. The diamine used to prepare the diamine alkoxylate of the invention preferably possessed two of the above-described primary amine groups.

Each of the polyalkylene oxide branches of the diamine alkoxylate can comprise or consist of on average:
a) at least 1 ethylene oxide unit (EOs); and
b) at least 5 polypropylene oxide units (POs), preferably at least 7 POs.

Each of the polyalkylene oxide branches of the diamine alkoxylate can comprise or consist of on average:
a) not more than 5 EOs, preferably not more than 4 EOs, preferably not more than 3 EOs, preferably not more than 2 EOs; and
b) not more than 12 POs, preferably not more than 11 POs.

In preferred embodiments, one alkylene oxide branch has an average molecular weight ranging from 300 g/mol to 1050 g/mol, preferably from 350 g/mol to 750 g/mol.

Diamine alkoxylates bearing the above-described modification can also be called being “alkoxylated”, “ethoxylated and propoxylated” and/or “modified”

Each of the polyalkylene oxide branches can comprise a block or random structure of ethylene oxide and propylene oxide, preferably a block structure, more preferably a polyethylene oxide and polypropylene oxide block and even more preferably the diamine is first modified with the polypropylene oxide and secondly with the polyethylene oxide block.

The (poly)alkylene oxide branches preferably possess a block structure consisting of a (poly) PO block and an (poly) EO block, wherein the (poly) PO block is reacted with the —NH₂ groups of the diamine. Alternatively, the polyalkylene oxide branches possess a block structure consisting of an (poly) EO block and a (poly) PO block, wherein the (poly) EO block is reacted with the —NH₂ groups of the diamine.

The skilled person will understand that the diamine may also be alkoxylated with other AOs than ethylene oxide or propoxylene oxide. In this context, butylene oxide is mentioned. Further, the skilled person is also well-aware of helpful modifications of the alkoxy chain, such as modifications with lactones or hydroxy carbon acid as described in WO2021165468 A. More preferably, the diamine alkoxylate comprises alkoxylates selected from the group consisting of PO and EO.

The polyalkylene oxide branches may consist of ethylene oxides and propylene oxides. The polyalkylene oxide branches preferably end with an-OH group but may alternatively be capped, such as with a C1 to C20 alkyl group, preferably C1 to C6 alkyl group, more preferably Cl alkyl group.

The term “polyalkylene oxide branch”, as used herein, refers to a sub-structure of the inventive compounds comprising, essentially consisting of or consisting of a plurality of AO units, namely EO units and PO units.

In the diamine alkoxylate of use in the present invention, at least three NH-functionalities, preferably all NH-functionalities are modified with alkylene oxide (AO) units.

All polyalkylene oxide branches attached to the NH-functionalities of the diamine can have the same structure, in that sense that the number of EO and PO units per polyalkylene oxide branch is identical or, alternatively, the (poly)alkylene oxide branch structures vary slightly.

Without wishing being bound by the following explanation, a rationale exists to explain the resulting structures of the diamine alkoxylates: Due to the fact that the reactions in questions necessarily employed to prepare those structural orders of the side chains, and thus to prepare the specific inventive compounds, are reactions of quite reactive species which can lead under suitable conditions to almost complete and even “essentially complete” conversions of almost 100% if not even 100%, the statistical deviation of the composition of the mixture of “diamine alkoxylate” in question is not that high, which in turn means that the structural order of the side chains do not show much deviation. Thus, it is a reliable assumption which can in principle be proven by sophisticated and thus time-consuming and expensive analytical means—such as multi-dimensional NMR-analyses—that it is generally accepted that such deviation exists; hence, no “specific diamine alkoxylate” will be “just one chemical compound of a clearly defined chemical structure”, but clearly will consist of a a) mixture of slightly differing compounds, such differences lying in b) slight deviations may already in the structure of compound making up “the (unmodified) diamine” being employed for the further modification steps, and c) the slight deviations in the structural orders of the side chains may be attached by way of d) multi-step reactions due to c) variations in the chemical reactivities of the —NH₂ groups, and f) due to slight inhomogeneities occurring in a commercial scale process. All of those factors a) to f)—to just mention a few important ones-lead to a “specific diamine alkoxylate” which is not one specific chemical compound but in fact a mixture of slightly differing compounds having an overall very similar chemical structure; thus, such structure is best described by average numbers for the variables and percentages for the amounts of the dominating structural order.

The weight average molecular weight (Mw) of the diamine alkoxylate can be in the range of from 1,500 g/mol to 3,000 g/mol, preferably in the range of from 2,000 g/mol to 2,900 g/mol, more preferably in the range of from 2,500 g/mol to 2,800 g/mol.

The diamine used to make the diamine alkoxylate can have a molecular weight ranging from 50 g/mol to 1500 g/mol, preferably from 60 g/mol to 1000 g/mol and more preferably from 60 g/mol to 200 g/mol. Suitable diamines can be selected from the group consisting of: 1,2-diaminocthane (EDA), 1,3-diaminopropane, 2,2-dimethyl-1,3-diaminopropane, 1,4-diaminobutane, 1,5-diaminopentane, 1,6-diaminohexane, 1,7-diaminoheptane, 1,8-diaminooctane, cyclohexyl-diamine and methylcyclohexyl-diamine.

The diamine alkoxylate preferably demonstrates at least 20%, preferably at least 40% or more preferably at least 60% biodegradability according to standard OECD 301F after 56 days, preferably after 28 days.

The diamine alkoxylate may comprise secondary amines that originate from primary amine groups of the diamine which are modified with only a single polyalkylene oxide branch. By secondary amine, as used herein, an amine is meant in which the nitrogen atom is attached to two carbon atoms and one hydrogen atom. On the other hand, the inventive compounds can comprise tertiary amine groups that originate from the reacted secondary amine groups of the diamine and which are reacted with an additional polyalkylene oxide branch. Alternatively and preferably, the inventive compounds can comprise tertiary amine groups that originate from the primary amine groups of the diamine which has alkoxylated with a single or small amount of alkoxyl unit and which are subsequently reacted with alkylene oxide monomers to obtain the two polyalkylene oxide branches. As mentioned above, in preferred embodiments all (four) NH-functionalities are modified with alkylene oxide (AO) units, namely ethylene oxide (EO) units and propylene oxide (PO) units, meaning that these compounds only comprise tertiary amine groups.

The amount of secondary amine groups in the diamine alkoxylate can be measured according to methods known to the skilled person, such as NMR-spectroscopy, such as 13C-NMR-spectroscopy and/or 1H NMR-spectroscopy.

Suitable diamine alkoxylates can be made via processes wherein a diamine that has at least two, preferably two, primary amine groups is reacted with (i) at least 20 propylene oxide molecules and (ii) at least 4 ethylene oxide molecules in order to obtain the respective diamine alkoxylate.

The diamine can be reacted with (i) 3 to 32, 4 to 16 or 4 to 9 ethylene oxide molecules and (ii) 16 to 50, 18 to 48 or 20 to 45 propylene oxide molecules in order to obtain the respective diamine alkoxylate.

The diamine is preferably selected from the group consisting of 1,2-diaminoethane (EDA), 1,3-diaminopropane, 2,2-dimethyl-1,3-diaminopropane, 1,4-diaminobutane, 1,5-diaminopentane, 1,6-diaminohexane, 1,7-diaminoheptane, 1,8-diaminooctane, cyclohexyl-diamine and methylcyclohexyl-diamine.

The conversion rate of the reaction step may be monitored and in preferred embodiments the conversion rate for this step is at least 95%, preferably at least 99%, and even more preferably at least 99.5% or even more. All other structural orders of the side chains as defined above but also the undefined structures resulting from non-controllable parameters are performed in this defined manner, leading—on statistical average—to a defined structural order directly derived from the way such reaction is performed.

The conversion rate of the reaction can be determined according to methods known to the skilled person, such as NMR-spectroscopy, such as 13C-NMR-spectroscopy and/or 1H NMR-spectroscopy.

Suitable reaction conditions such as catalysts, temperatures, duration, purification etc. of the reactions to produce the units of the side chains of the diamine alkoxylate, can be obtained from the disclosures EP3298120 A, JP2022056680 A and U.S. Pat. No. 7,468,348 B.

The alkoxylation can be carried out in the presence of at least one catalyst. Within this step reaction of the alkoxylation step, the catalyst is preferably a basic catalyst. Examples of suitable catalysts are alkali metal and alkaline earth metal hydroxides such as sodium hydroxide, potassium hydroxide and calcium hydroxide, alkali metal alkoxides, in particular sodium and potassium C₁-C₄-alkoxides, such as sodium methoxide, sodium ethoxide and potassium tert-butoxide, alkali metal and alkaline earth metal hydrides such as sodium hydride and calcium hydride, and alkali metal carbonates such as sodium carbonate and potassium carbonate. Preference is given to the alkali metal hydroxides and the alkali metal alkoxides, a particular preference being given to potassium hydroxide and sodium hydroxide. Typical use amounts for the base are from 0.05 to 10% by weight of final product, in particular from 0.05 to 2% by weight, based on the total amount of the diamine and alkylene oxide.

The diamine alkoxylate can be further submitted to the following process steps of
a) purification using standard means such as steam distillation, thermal distillation, vacuum evaporation, including removal of all solvent, dialysis and/or
b) drying using standard drying means such as spray-, drum, paddle-, vacuum-drying means including agglomeration methods such as fluidized-bed-drying,
to obtain a purified solution, a purified liquid, a solid compound or a purified solid compound.

In case that after the reactions leading to the diamine alkoxylates of use in the present invention, residual educts (diamine and/or alkylene oxide) are present to a non-desirable extent, the resulting product mixture containing the diamine alkoxylate may be further purified by standard means to reduce the content of residual educts, but also to reduce the amount of possible by-products, reduce the amount(s) of the solvent(s) employed (i.e., to concentrate) or replace solvent(s) with other solvents. Such processes are known to a person of skill in this field.

Preferably, undesirable amounts of residual non-reacted educts are removed, preferably by means of distillative processes, more preferably by thermal distillative processes, which may additionally comprise the application of reduced pressure to increase the speed and/or the effectiveness of the removal.

In a preferred embodiment only the additional process step a) is employed.

The terms “essentially having” or “having essentially”, as used interchangeably herein, with respect to the diamine core mean that the diamine core may comprise impurities or other types of amines in an amount up to not more than 10% w/w, not more than 7% w/w, not more than 5% w/w, not more than 3% w/w, not more than 2% w/w, not more than 1% w/w, not more than 0.5% w/w or not more than 0.1% w/w.

### Surfactant System

The liquid composition comprises from 5.0% to 50%, preferably from 6.0% to 40%, most preferably from 15% to 35%, by weight of the total composition of a surfactant system.

### Anionic Surfactant:

The surfactant system comprises an anionic surfactant. The surfactant system can comprise at least 40%, preferably from 50% to 90%, more preferably from 65% to 85% by weight of the surfactant system of the anionic surfactant. The surfactant system is preferably free of fatty acid or salt thereof, since such fatty acids impede the generation of suds.

Suitable anionic surfactants can be selected from the group consisting of: alkyl sulfate surfactant, alkyl alkoxy sulfate surfactant, alkyl sulfonate surfactant, alkyl sulfosuccinate and dialkyl sulfosuccinate ester surfactants, and mixtures thereof.

The anionic surfactant can comprise at least 70%, preferably at least 85%, more preferably 100% by weight of the anionic surfactant of alkyl sulfate anionic surfactant, alkyl alkoxy sulfate anionic surfactant, or a mixture thereof.

The mol average alkyl chain length of the alkyl sulfate anionic surfactant or the alkyl alkoxy sulfate anionic surfactant can be from 8 to 18, preferably from 10 to 14, more preferably from 12 to 14, most preferably from 12 to 13 carbon atoms, in order to provide a combination of improved grease removal and enhanced speed of cleaning.

The alkyl chain of the alkyl sulfate anionic surfactant or the alkyl alkoxy sulfate anionic surfactant can have a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain is at least 57/43, preferably from 60/40 to 90/10, more preferably from 60/40 to 80/20, most preferably from 60/40 to 70/30, while not compromising suds mileage in the presence of particulate soils.

The relative molar amounts of C13 and C12 alkyl chains in the alkyl sulfate anionic surfactant or the alkyl alkoxy sulfate anionic surfactant can be derived from the carbon chain length distribution of the surfactants. The carbon chain length distributions of the alkyl chains of the alkyl sulfate and alkyl alkoxy sulfate surfactants can be obtained from the technical data sheets from the suppliers for the surfactant or constituent alkyl alcohol. Alternatively, the chain length distribution and average molecular weight of the fatty alcohols, used to make the alkyl sulfate anionic surfactant or the alkyl alkoxy sulfate anionic surfactant, can also be determined by methods known in the art. Such methods include capillary gas chromatography with flame ionization detection on medium polar capillary column, using hexane as the solvent. The chain length distribution is based on the starting alcohol and alkoxylated alcohol. As such, the alkyl sulfate anionic surfactant should be hydrolyzed back to the corresponding alkyl alcohol and alkyl alkoxylated alcohol before analysis, for instance using hydrochloric acid.

The alkyl alkoxy sulfate surfactant can have an average degree of alkoxylation of less than 3.5, preferably less than 2.0, more preferably 1.0 or less. Alternatively, the alkyl alkoxy sulfate surfactant can have an average degree of alkoxylation of less than 3.5, preferably from 0.3 to 2.0, more preferably from 0.5 to 0.9, in order to improve low temperature physical stability and improve suds mileage of the compositions of the present invention. When alkoxylated, ethoxylation is preferred.

The average degree of alkoxylation is the mol average degree of alkoxylation (i.e., mol average alkoxylation degree) of all the alkyl sulfate anionic surfactant. Hence, when calculating the mol average alkoxylation degree, the mols of non-alkoxylated sulfate anionic surfactant are included:

$$Mol average alkoxylation degree = ( x 1 * alkoxylation degree of surfactant 1 + x 2 * alkoxylation degree of surfactant 2 + … ) / ( x 1 + x 2 + … )$$

where x1, x2, . . . are the number of moles of each alkyl (or alkoxy) sulfate anionic surfactant of the mixture and alkoxylation degree is the number of alkoxy groups in each alkyl sulfate anionic surfactant.

Preferred alkyl alkoxy sulfates are alkyl ethoxy sulfates.

The alkyl sulfate anionic surfactant and the alkyl alkoxy sulfate anionic surfactant can have a weight average degree of branching of at least 10%, preferably from 20% to 60%, more preferably from 25% to 45%. Alternatively, the alkyl sulfate anionic surfactant and the alkyl alkoxy sulfate anionic surfactant can have a weight average degree of branching of less than 10%, preferably the alkyl sulfate anionic surfactant and the alkyl alkoxy sulfate anionic surfactant are free of branching.

The alkyl sulfate anionic surfactant and the alkyl alkoxy sulfate anionic surfactant can comprise at least 5%, preferably at least 10%, most preferably at least 25%, by weight of the surfactant, of branching on the C2 position (as measured counting carbon atoms from the sulfate group for non-alkoxylated alkyl sulfate anionic surfactants and counting from the alkoxy-group furthest from the sulfate group for alkoxylated alkyl sulfate anionic surfactants). More preferably, greater than 75%, even more preferably greater than 90%, by weight of the total branched alkyl content consists of C1-C5 alkyl moiety, preferably C1-C2 alkyl moiety. It has been found that formulating the inventive compositions using alkyl sulfate surfactants or alkyl alkoxy sulfate surfactants having the aforementioned degree of branching results in improved low temperature stability. Such compositions require less solvent in order to achieve good physical stability at low temperatures. As such, the compositions can comprise lower levels of organic solvent, such as less than 5.0% by weight of the liquid composition of organic solvent, while still having improved low temperature stability. Higher surfactant branching also provides faster initial suds generation, but typically less suds mileage. The weight average branching, described herein, has been found to provide improved low temperature stability, initial foam generation and suds longevity.

The weight average degree of branching for an anionic surfactant mixture can be calculated using the following formula:

$$Weight average degree of branching ( \% ) = [ ( x 1 * wt \% branched alcohol 1 in alcohol 1 + x 2 * wt \% branched alcohol 2 in alcohol 2 + … ) / ( x 1 + x 2 + … ) ] * 100$$

where x1, x2, . . . are the weight in grams of each alcohol in the total alcohol mixture of the alcohols which were used as starting material before (alkoxylation and) sulfation to produce the alkyl (alkoxy) sulfate anionic surfactant. In the weight average degree of branching calculation, the weight of the alkyl alcohol used to form the alkyl sulfate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionization detection on medium polar capillary column, using hexane as the solvent. The weight average degree of branching and the distribution of branching is based on the starting alcohol used to produce the alkyl sulfate anionic surfactant.

Suitable counterions include alkali metal cation earth alkali metal cation, alkanolammonium or ammonium or substituted ammonium, but preferably sodium.

Suitable examples of commercially available alkyl sulfate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired mol fraction of C12 and C13 chains and the desired C13/C12 ratio, based on the relative fractions of C13 and C12 within the starting alcohols, as obtained from the technical data sheets from the suppliers or from analysis using methods known in the art.

The performance can be affected by the width of the alkoxylation distribution of the alkoxylated alkyl sulfate anionic surfactant, including grease cleaning, sudsing, low temperature stability and viscosity of the finished product. The alkoxylation distribution, including its broadness can be varied through the selection of catalyst and process conditions when making the alkoxylated alkyl sulfate anionic surfactant.

If ethoxylated alkyl sulfate is present, without wishing to be bound by theory, through tight control of processing conditions and feedstock material compositions, both during alkoxylation especially ethoxylation and sulfation steps, the amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulfates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof.

Anionic alkyl sulfonate or sulfonic acid surfactants suitable for use herein include the acid and salt forms of alkylbenzene sulfonates, alkyl ester sulfonates, primary and secondary alkane sulfonates such as paraffin sulfonates, alfa or internal olefin sulfonates, alkyl sulfonated (poly) carboxylic acids, and mixtures thereof. Suitable anionic sulfonate or sulfonic acid surfactants include: C5-C20 alkylbenzene sulfonates, more preferably C10-C16 alkylbenzene sulfonates, more preferably C11-C13 alkylbenzene sulfonates, C5-C20 alkyl ester sulfonates especially C5-C20 methyl ester sulfonates, C6-C22 primary or secondary alkane sulfonates, C5-C20 sulfonated (poly) carboxylic acids, and any mixtures thereof, but preferably C11-C13 alkylbenzene sulfonates. The aforementioned surfactants can vary widely in their 2-phenyl isomer content. Compared with sulfonation of alpha olefins, the sulfonation of internal olefins can occur at any position since the double bond is randomly positioned, which leads to the position of hydrophilic sulfonate and hydroxyl groups of IOS in the middle of the alkyl chain, resulting in a variety of twin-tailed branching structures. Alkane sulfonates include paraffin sulfonates and other secondary alkane sulfonate (such as Hostapur SAS60 from Clariant).

Alkyl sulfosuccinate and dialkyl sulfosuccinate esters are organic compounds with the formula MO3SCH (CO2R′)CH2CO2R where R and R′ can be H or alkyl groups, and M is a counter-ion such as sodium (Na). Alkyl sulfosuccinate and dialkyl sulfosuccinate ester surfactants can be alkoxylated or non-alkoxylated, preferably non-alkoxylated. The surfactant system may comprise further anionic surfactant. However, the composition preferably comprises less than 30%, preferably less than 15%, more preferably less than 10% by weight of the surfactant system of further anionic surfactant. Most preferably, the surfactant system comprises no further anionic surfactant, preferably no other anionic surfactant than alkyl sulfate anionic surfactant.

### Co-Surfactant:

In order to improve surfactant packing after dilution and hence improve suds mileage, the surfactant system can comprise a co-surfactant which is selected from the group consisting of an amphoteric surfactant, a zwitterionic surfactant and mixtures thereof.

The anionic surfactant to the co-surfactant weight ratio can be from 1:1 to 8:1, preferably from 2:1 to 5:1, more preferably from 2.5:1 to 4:1.

The composition preferably comprises from 0.1% to 20%, more preferably from 0.5% to 15% and especially from 2% to 10% by weight of the cleaning composition of the co-surfactant.

The surfactant system of the cleaning composition of the present invention preferably comprises up to 50%, preferably from 10% to 40%, more preferably from 15% to 35%, by weight of the surfactant system of a co-surfactant.

The co-surfactant is preferably an amphoteric surfactant, more preferably an amine oxide surfactant.

The amine oxide surfactant can be linear or branched, though linear are preferred. Suitable linear amine oxides are typically water-soluble, and characterized by the formula R1-N(R2) (R3) O. R1 is a C8-18 alkyl, RI is preferably is a linear alkyl chain, more preferably derived from natural, renewable resources such as coconut or palm kernel, with coconut being particularly preferred. R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkylamidopropyl dimethyl amine oxide, and mixtures thereof.

Alkyl dimethyl amine oxides are particularly preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the α carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1-n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition of the invention can then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Suitable zwitterionic surfactants include betaine surfactants. Such betaine surfactants includes alkyl betaines, alkylamidobetaines, amidazoliniumbetaines, sulfobetaine (INCI Sultaines), phosphobetaines, and mixtures thereof, and preferably meets formula (I):

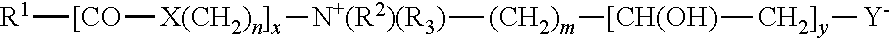

Wherein in formula (I),
R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue; R1 is preferably a linear alkyl chain, preferably derived from natural, renewable resources such as coconut or palm kernel, preferably coconut.

X is selected from the group consisting of: NH, NR4 wherein R4 is a C1-4 alkyl residue, O, and S,
n is an integer from 1 to 10, preferably 2 to 5, more preferably 3,
x is 0 or 1, preferably 1,
R2 and R3 are independently selected from the group consisting of: a C1-4 alkyl residue, hydroxy substituted such as a hydroxyethyl, and mixtures thereof, preferably both R2 and R3 are methyl,
m is an integer from 1 to 4, preferably 1, 2 or 3,
y is 0 or 1, and
Y is selected from the group consisting of: COO, SO3, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulfobetaine of formula (Ic) and the amido sulfobetaine of formula (Id):

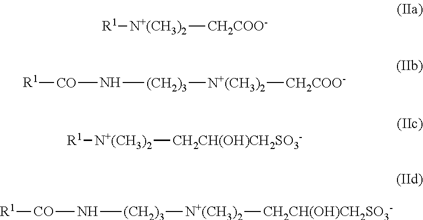

in which R1 has the same meaning as in formula (I). Particularly preferred are the carbobetaines [i.e. wherein Y—=COO— in formula (I)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine and/or laurylamidopropylbetaine are particularly preferred.

### Nonionic Surfactant:

The surfactant system can further comprise a nonionic surfactant. Suitable nonionic surfactants include alkoxylated alcohol nonionic surfactants, alkyl polyglucoside nonionic surfactants, and mixtures thereof, preferably alkoxylated alcohol nonionic surfactants.

### Alkoxylated Alcohol Nonionic Surfactant:

If present, the surfactant system of the composition of the present invention can comprise from 0.1% to 10%, preferably from 2.0% to 9.0%, more preferably from 4.0% to 8.0% by weight of the detergent composition, of an alkoxylated alcohol non-ionic surfactant.

Preferably, the alkoxylated alcohol non-ionic surfactant is a linear or branched, primary or secondary alkyl alkoxylated non-ionic surfactant, preferably an alkyl ethoxylated non-ionic surfactant, preferably comprising on average from 9 to 15, preferably from 10 to 14 carbon atoms in its alkyl chain and on average from 5 to 12, preferably from 6 to 10, most preferably from 7 to 8, units of ethylene oxide per mole of alcohol.

### Alkyl Polyglucoside Nonionic Surfactant:

If present, the alkyl polyglucoside can be present in the surfactant system at a level of from 0.1% to 10%, preferably from 2.0% to 9.0%, more preferably from 4.0% to 8.0% by weight of the detergent composition. Alkyl polyglucoside nonionic surfactants are typically more sudsing than other nonionic surfactants such as alkyl ethoxlated alcohols.

A combination of alkylpolyglucoside and anionic surfactant especially alkyl sulfate anionic surfactant, has been found to improve polymerized grease removal, suds mileage performance, reduced viscosity variation with changes in the surfactant and/or system, and a more sustained Newtonian rheology.

The alkyl polyglucoside surfactant can be selected from C6-C18 alkyl polyglucoside surfactant. The alkyl polyglucoside surfactant can have a number average degree of polymerization of from 0.1 to 3.0, preferably from 1.0 to 2.0, more preferably from 1.2 to 1.6. The alkyl polyglucoside surfactant can comprise a blend of short chain alkyl polyglucoside surfactant having an alkyl chain comprising 10 carbon atoms or less, and mid to long chain alkyl polyglucoside surfactant having an alkyl chain comprising greater than 10 carbon atoms to 18 carbon atoms, preferably from 12 to 14 carbon atoms.

Short chain alkyl polyglucoside surfactants have a monomodal chain length distribution between C8-C10, mid to long chain alkyl polyglucoside surfactants have a monomodal chain length distribution between C10-C18, while mid chain alkyl polyglucoside surfactants have a monomodal chain length distribution between C12-C14. In contrast, C8 to C18 alkyl polyglucoside surfactants typically have a monomodal distribution of alkyl chains between C8 and C18, as with C8 to C16 and the like. As such, a combination of short chain alkyl polyglucoside surfactants with mid to long chain or mid chain alkyl polyglucoside surfactants have a broader distribution of chain lengths, or even a bimodal distribution, than non-blended C8 to C18 alkyl polyglucoside surfactants. Preferably, the weight ratio of short chain alkyl polyglucoside surfactant to long chain alkyl polyglucoside surfactant is from 1:1 to 10:1, preferably from 1.5:1 to 5:1, more preferably from 2:1 to 4:1. It has been found that a blend of such short chain alkyl polyglucoside surfactant and long chain alkyl polyglucoside surfactant results in faster dissolution of the detergent solution in water and improved initial sudsing, in combination with improved suds stability.

C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain APG surfactant. Glucopon® 600CSUP is a preferred mid to long chain APG surfactant.

In preferred compositions, the surfactant system can comprise an alkyl sulfate anionic surfactant having an average degree of branching of less than 10% and alkyl polyglucoside nonionic surfactant.

### Divalent Salts

The composition preferably comprises a divalent metal salt, preferably a salt of Calcium or Magnesium (Ca²⁺ or Mg²⁺ salt). Suitable divalent salts include magnesium and/or calcium salts of: chlorides, sulfates, carbonates, bicarbonates, linear alkyl benzene sulfonic acid, and mixtures thereof, with magnesium salts being particularly preferred. Magnesium salts of chlorides, sulfates, linear alkyl benzene sulfonic acid, and mixtures thereof are particularly preferred, more particularly magnesium salts of chlorides, sulfates, and mixtures thereof, with magnesium chloride being most preferred.

If calcium salts are present, the magnesium ions and calcium ions are preferably present in a molar ratio of 1:1 or greater, preferably 1.5:1 or greater, preferably 2:1 or greater.

Compositions of the present invention, which further comprise such divalent salts have been found to improve cleaning as well as reduce the slipperiness of the dishware after they have been cleaned with such compositions. It is believed that some residual anionic surfactant remains on the dishware, and the presence of the divalent ions reduces the electrostatic interaction between the residual anionic surfactant, both improving cleaning and reducing slipperiness, especially when the dishware is washed using soft water having a hardness of less than 1.25 mmol/l calcium equivalence.

The divalent salts are preferably water-soluble. As used herein, the term “water-soluble” refers to a compound that can be dissolved in water at a concentration of more than 1.0% by weight in distilled water at 21° C.

### Further Ingredients

The composition can comprise further ingredients such as those selected from: triblock copolymers, hydrotropes, organic solvents, other adjunct ingredients such as those described herein, and mixtures thereof.

### Triblock Copolymer:

The composition of the invention can comprise a triblock copolymer. The triblock co-polymers can be present at a level of from 1% to 20%, preferably from 3% to 15%, more preferably from 5% to 12%, by weight of the total composition. Suitable triblock copolymers include alkylene oxide triblock co-polymers, defined as a triblock co-polymer having alkylene oxide moieties according to Formula (I): (EO) x (PO) y (EO) x, wherein EO represents ethylene oxide, and each x represents the number of EO units within the EO block. Each x can independently be on average of from 5 to 50, preferably from 10 to 40, more preferably from 10 to 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y can on average be from between 28 to 60, preferably from 30 to 55, more preferably from 30 to 48.

Preferably the triblock co-polymer has a ratio of y to each x of from 3:1 to 2:1. The triblock co-polymer preferably has a ratio of y to the average x of 2 EO blocks of from 3:1 to 2:1. Preferably the triblock co-polymer has an average weight percentage of total E-O of between 30% and 50% by weight of the tri-block co-polymer. Preferably the triblock co-polymer has an average weight percentage of total PO of between 50% and 70% by weight of the triblock co-polymer. It is understood that the average total weight % of EO and PO for the triblock co-polymer adds up to 100%. The triblock co-polymer can have an average molecular weight of between 2060 and 7880, preferably between 2620 and 6710, more preferably between 2620 and 5430, most preferably between 2800 and 4700. Average molecular weight is determined using a 1H NMR spectroscopy (see Thermo scientific application note No. AN52907).

Triblock co-polymers have the basic structure ABA, wherein A and B are different homopolymeric and/or monomeric units. In this case A is ethylene oxide (EO) and B is propylene oxide (PO). Those skilled in the art will recognize the phrase “block copolymers” is synonymous with this definition of “block polymers”.

Triblock co-polymers according to Formula (I) with the specific EO/PO/EO arrangement and respective homopolymeric lengths have been found to enhances suds mileage performance of the liquid hand dishwashing detergent composition in the presence of greasy soils and/or suds consistency throughout dilution in the wash process.

Suitable EO-PO-EO triblock co-polymers are commercially available from BASF such as Pluronic® PE series, and from the Dow Chemical Company such as Tergitol™ L series. Particularly preferred triblock co-polymer from BASF are sold under the tradenames Pluronic® PE6400 (MW ca 2900, ca 40 wt % EO) and Pluronic® PE 9400 (MW ca 4600, 40 wt % EO). Particularly preferred triblock co-polymer from the Dow Chemical Company is sold under the tradename Tergitol™ L64 (MW ca 2700, ca 40 wt % EO).

Preferred triblock co-polymers are readily biodegradable under aerobic conditions.

### Cyclic Polyamine:

The composition can comprise a cyclic polyamine having amine functionalities that helps cleaning. The composition of the invention preferably comprises from 0.1% to 3%, more preferably from 0.2% to 2%, and especially from 0.5% to 1%, by weight of the composition, of the cyclic polyamine.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is-CH3 and the rest are H provided for improved grease cleaning performance.

Accordingly, the most preferred cyclic polyamine for use with the cleaning composition of the present invention are cyclic polyamine selected from the group consisting of: 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present invention.

Suitable cyclic polyamines can be supplied by BASF, under the Baxxodur tradename, with Baxxodur ECX-210 being particularly preferred.

A combination of the cyclic polyamine and magnesium sulfate is particularly preferred. As such, the composition can further comprise magnesium sulfate at a level of from 0.001% to 2.0%, preferably from 0.005% to 1.0%, more preferably from 0.01% to 0.5% by weight of the composition.

### Salt, Hydrotrope, Organic Solvent:

The composition of the present invention may further comprise at least one active selected from the group consisting of: i) a salt, ii) a hydrotrope, iii) an organic solvent, and mixtures thereof.

The composition of the present invention may comprise from about 0.05% to about 2%, preferably from about 0.1% to about 1.5%, or more preferably from about 0.5% to about 1%, by weight of the total composition of a salt, preferably a monovalent or divalent inorganic salt, or a mixture thereof, more preferably selected from: sodium chloride, sodium sulfate, and mixtures thereof. Sodium chloride is most preferred.

The composition of the present invention may comprise from about 0.1% to about 10%, or preferably from about 0.5% to about 10%, or more preferably from about 1% to about 10% by weight of the total composition of a hydrotrope or a mixture thereof, preferably sodium cumene sulfonate.

The composition can comprise from about 0.1% to about 10%, or preferably from about 0.5% to about 10%, or more preferably from about 1% to about 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol, is the preferred glycol, with polypropyleneglycols having a weight average molecular weight of from 750 Da to 1,400 Da being particularly preferred.

### Adjunct Ingredients

The composition may optionally comprise a number of other adjunct ingredients such as builders (preferably citrate), chelants, conditioning polymers, other cleaning polymers, surface modifying polymers, structurants, emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, carbonates such as sodium carbonates, bicarbonates, sesquicarbonates, and alike).

### Packaged Product

The hand dishwashing detergent composition can be packaged in a container, typically plastic containers. Suitable containers comprise an orifice. Suitable containers include traditional upright dosing containers, where the orifice is at the top of the container, and inverted/bottom dosing containers, where the orifice is at the bottom of the container. For inverted/bottom dosing containers, the orifice may be capped and/or the orifice may comprise a slit valve, such as described in U.S. Pat. No. 10,611,531. Typically, the container comprises a cap, with the orifice typically comprised on the cap. The cap can comprise a spout, with the orifice at the exit of the spout. The spout can have a length of from 0.5 mm to 10 mm.

The orifice can have an open cross-sectional surface area at the exit of from 3 mm2 to 20 mm2, preferably from 3.8 mm2 to 12 mm2, more preferably from 5 mm2 to 10 mm2, wherein the container further comprises the composition according to the invention. The cross-sectional surface area is measured perpendicular to the liquid exit from the container (that is, perpendicular to the liquid flow during dispensing).

The container can typically comprise from 200 ml to 5,000 ml, preferably from 350 ml to 2000 ml, more preferably from 400 ml to 1,000 ml of the liquid hand dishwashing detergent composition.

### Method of Washing

The invention is further directed to a method of manually washing dishware with the composition of the present invention. The method comprises the step of contacting the dishware with a composition according to the present invention.

Suitable methods can include the step of delivering a composition of the present invention to a volume of water to form a wash solution and immersing the dishware in the solution, in order to contact the dishware with the composition of the present invention. The dishware is then cleaned with the composition in the presence of water.

The dishware can be rinsed. By “rinsing”, it is meant herein contacting the dishware cleaned with the process according to the present invention with substantial quantities of appropriate solvent, typically water. By “substantial quantities”, it is meant usually about 1 to about 20 L, or under running water.

The composition herein can be applied in its diluted form. Soiled dishware is contacted with an effective amount, typically from about 0.5 mL to about 20 mL (per about 25 dishes being treated), preferably from about 3 mL to about 10 mL, of the composition, preferably in liquid form, of the present invention diluted in water. The actual amount of composition used will be based on the judgment of the user and will typically depend upon factors such as the particular product formulation of the composition, including the concentration of active ingredients in the composition, the number of soiled dishes to be cleaned, the degree of soiling on the dishes, and the like. Generally, from about 0.01 mL to about 150 mL, preferably from about 3 mL to about 40 mL of a composition of the invention is combined with from about 2,000 mL to about 20,000 mL, more typically from about 5,000 mL to about 15,000 mL of water in a sink. The soiled dishware is immersed in the sink containing the diluted compositions then obtained, before contacting the soiled surface of the dishware with a cloth, sponge, or similar cleaning implement. The cloth, sponge, or similar cleaning implement may be immersed in the composition and water mixture prior to being contacted with the dishware, and is typically contacted with the dishware for a period of time ranged from about 1 to about 10 seconds, although the actual time will vary with each application and user. The contacting of cloth, sponge, or similar cleaning implement to the dishware is accompanied by a concurrent scrubbing of the dishware.

Alternatively, the composition herein can be applied in its neat form to the dish to be treated. By “in its neat form”, it is meant herein that said composition is applied directly onto the surface to be treated, or onto a cleaning device or implement such as a brush, a sponge, a nonwoven material, or a woven material, without undergoing any significant dilution by the user (immediately) prior to application. “In its neat form”, also includes slight dilutions, for instance, arising from the presence of water on the cleaning device, or the addition of water by the consumer to remove the remaining quantities of the composition from a bottle. Therefore, the composition in its neat form includes mixtures having the composition and water at ratios ranging from 50:50 to 100:0, preferably 70:30 to 100:0, more preferably 80:20 to 100:0, even more preferably 90:10 to 100:0 depending on the user habits and the cleaning task.

### Test Methods

### Polymer Biodegradation

Biodegradation in wastewater was tested in triplicate using the OECD 301F manometric respirometry method. OECD 301F is an aerobic test that measures biodegradation of a sample by measuring the consumption of oxygen. To a measured volume of medium, 100 mg/L test substance, which is the nominal sole source of carbon is added along with the inoculum (30 mg/L, aerated sludge taken from Mannheim wastewater treatment plant). This is stirred in a closed flask at a constant temperature (20° C. or 25° C.) for 28 or 56 days, respectively. The consumption of oxygen is determined by measuring the change in pressure in the apparatus using an OxiTop® C (Xylem 35 Analytics Germany Sales GmbH & Co KG). Evolved carbon dioxide is absorbed in a solution of sodium hydroxide. Nitrification inhibitors are added to the flask to prevent usage of oxygen due to nitrification. The amount of oxygen taken up by the microbial population during biodegradation of the test substance (corrected for uptake by blank inoculum, run in parallel) is expressed as a percentage of ThOD (Theoretical oxygen demand, which is measured by the elemental analysis of the compound). A positive control Glucose/Glucosamine is run along with the test samples for each cabinet.

### Diamine Alkoxylate Molecular Weight, % PO, % EO, % Diamine Core

The person skilled in the art knows how to determine/measure the respective weight average molecular weight (Mw). This can be done, for example, by using size exclusion chromatography (such as GPC, e.g., in combination with light scattering), by mass spectrometry, by mass photometry or by calculation from the used molar ratio of starting materials.

Preferably, Mw values are determined by the method as follows: OECD TG 118 (1996), which means in detail OECD (1996), Test No. 118: Determination of the Number-Average Molecular Weight and the Molecular Weight Distribution of Polymers using Gel Permeation Chromatography, OECD Guidelines for the Testing of Chemicals, Section 1, OECD Publishing, Paris, also available on the internet, for example, under https://doi.org/10.1787/9789264069848-en.

Molecular weights of the starting materials may be determined as described above. Molecular weights of the diamine alkoxylate may be determined by gel permeation chromatography (GPC). The samples were prepared as follows: approx. 15 mg sample was dissolved in 10 ml eluent (THF+0.035 mol/L Diethanolamine) for 1 hour at a temperature of 50° C. All sample solutions were filtered by a Chromafil Xtra PTFE (0.20 μm filtered prior to injection). Sealed sample vials were placed into the auto sampler. An Agilent 1200 HPLC system, consisting of an isocratic pump, vacuum degasser, auto sampler and a column oven was used. Furthermore, the Agilent system contains a Differential Refractive Index (DRI) and a variable Ultra Violet (UVW) Detector for detection. Data acquisition and data processing of conventionally SEC data was done by WinGPC Unichrom, build 6999, of PSS (Polymer Standard Services now part of Agilent). A combination of a SDV guard (7.5×50 mm) column and 3 SDV columns (1000 A, 100000 A and 1000000 A, all 7.5×300 mm) of PSS were put in series at 60° C. THF+0.035 mol/L Diethanolamine was used as eluent at a flow rate of 1 mL/min. 100 μL of each sample solution was injected. The calibration was obtained by narrow molar mass distributed polyalkoxylene oxide (EO and PO mixtures) standards (Agilent) having a molar mass range of M=160 till M=1.378.000 g/mol. Molar masses outside this range were extrapolated.

“Mw” is the weight average molecular weight and “Mn” is number average molecular weight. The respective values of Mw and/or Mn can be determined as described within the experimental section below.

The molar mass distribution Mw/Mn obtained by GPC is equal to the polydispersity index (PDI), the PDI being without unit [g/mol/g/mol]).

For the diamine alkoxylate described herein, the molecular weight (MW) can also be calculated from the used molar ratio of starting materials. Typically, the molecular weight (MW) of the alkoxylated polymers can be calculated using equation below:

$$MW of the diamine alkoxylate = MW of diamine + total MW of PO + total MW of EO + total MW of other monomers ( if present ) .$$

The % by weight of PO, or % by weight of EO, or % by weight of diamine in the alkoxylated polymers can be calculated follow the same principle.

It is clear for a person skilled in the art that for the alkoxylated polymers of this invention, the measured molecular weight by GPC, mass spectroscopy or mass photometry and calculated molecular weight are consistent in that sense that the results for the measured molecular weight do not vary significantly.

### Suds Mileage Index in the Presence of Greasy Soil

Suds mileage performance in the presence of greasy soil was evaluated using the following method:

The objective of the Suds Mileage Index test is to compare the evolution over time of suds volume generated for different test formulations at specified water hardness, solution temperatures and formulation concentrations, while under the influence of periodic soil injections. Data are compared and expressed versus a reference composition as a suds mileage index (reference composition has suds mileage index of 100). The steps of the method are as follows:
1) A defined amount of a test composition, depending on the targeted composition concentration (0.12 wt %), is dispensed through a plastic pipette at a flow rate of 0.67 mL/see at a height of 37 cm above the bottom surface of a sink (dimension: 300 mm diameter and 288 mm height) into a water stream (using water at 1.25 mmol/l Ca equivalence (7 dH) water hardness at 42° C.) that is filling up the sink to 4 L with a constant pressure of 4 bar.
2) An initial suds volume generated (measured as average foam height×sink surface area and expressed in cm³) is recorded immediately after end of filling.
3) A fixed amount (6 mL) of soil is immediately injected into the middle of the sink.
4) The resultant solution is mixed with a metal blade (10 cm×5 cm) positioned in the middle of the sink at the air liquid interface under an angle of 45 degrees rotating at 85 RPM for 20 revolutions.
5) Another measurement of the total suds volume is recorded immediately after end of blade rotation.
6) Steps 3-5 are repeated until the measured total suds volume reaches a minimum level of 400 cm³. The amount of added soil that is needed to get to the 400 cm³ level is considered as the suds mileage for the test composition.
7) Each test composition is tested 4 times per testing condition (i.e., water temperature, composition concentration, water hardness, soil type).
8) The average suds mileage is calculated as the average of the 4 replicates for each sample.
9) Calculate a Suds Mileage Index by comparing the average mileage of a test composition sample versus a reference composition sample. The calculation is as follows:

$$Suds Mileage Index = \frac{Average number of soil addition of test composition}{Average number of soil addition of reference composition} \times 100$$

The soil composition is produced through standard mixing of the components described in Table 1.

TABLE 1
Greasy soil used for the suds mileage test.

| | wt % |
|---|---|
| Crisco ® oil | 12.730 |
| Crisco ® shortening | 27.752 |
| Lard | 7.638 |
| Refined rendered edible beef tallow | 51.684 |
| Oleic acid, 90% (Techn) | 0.139 |
| Palmitic acid, 99+% | 0.036 |
| Stearic acid, 99+% | 0.021 |

### Viscosity Measurement

The viscosity is measured using a controlled stress rheometer (such as an HAAKE MARS from Thermo Scientific, or equivalent), using a 60 mm 1° cone and a gap size of 52 microns at 20° C. After temperature equilibration for 2 minutes, the sample is sheared at a shear rate of 10 s⁻¹ for 30 seconds. The reported viscosity of the liquid hand dishwashing detergent compositions is defined as the average shear stress between 15 seconds and 30 seconds shearing divided by the applied shear rate of 10 s⁻¹ at 20° C.

pH

The pH is measured as a 10 wt % solution in demineralized water at 20° C., unless specified otherwise.

### EXAMPLES

The following inventive diamine alkoxylate were prepared as follows:

1,2-Ethylene Diamine, Propoxylated with 40 Mole Propylene Oxide and Ethoxylated with 8 Mole Ethylene Oxide (IE 5):

### Propoxylation of the Diamine:

In a 2 1 autoclave 102.3 g 1,2-ethylene diamine, propoxylated with 4 mole propylene oxide (Quadrol® L, BASF SE) and 1.7 g potassium tert. butoxide were placed and the mixture was heated to 140° C. The vessel was purged three times with nitrogen. 731.8 g propylene oxide was added continuously within 10 hours. To complete the reaction, the mixture was allowed to post-react for additional 10 hours at 140° C. The reaction mixture was stripped with nitrogen and volatile compounds were removed in vacuo (10 mbar) at 90° C. for 2 hours. 825.0 g of a light orange oil was obtained (hydroxyl number 103.3 mgKOH/g; amine number 52.3 mgKOH/g).

### Ethoxylation of the Propoxylated Diamine:

In a 2 1 autoclave 361.9 g of the previously produced propoxylated diamine (1,2-ethylene diamine, propoxylated with 40 moles propylene oxide) was heated to 130° C., and the vessel was purged three times with nitrogen. 53.1 g ethylene oxide was added continuously within 0.5 hours. To complete the reaction, the mixture was allowed to post-react for additional 5 hours at 130° C. The reaction mixture was stripped with nitrogen and volatile compounds were removed in vacuo (10 mbar) at 90° C. for 2 hours. 412.0 g of a light orange oil was obtained (hydroxyl number 88.3 mgKOH/g; amine number 46.9 mgKOH/g).

IE 1, IE 3, CE A, and CE B were prepared in a similar manner. IE 2 was prepared similarly, except that the propylene oxide and ethylene oxide were added together with the tert. butoxide and the reaction conducted at a temperature of 140° C. IE 4 was prepared by first reacting 1,2-ethylene diamine with ethylene oxide until an average of 1 EO per NH is achieved, and then ethoxylated before propoxylating as described above.

The structures are summarized in Table 1.

TABLE 1
Diamine alkoxylates of use in inventive (IE) and comparative
(CE) liquid hand dishwashing detergent compositions.

| | | wt % | wt % | | Biode- |
|---|---|---|---|---|---|
| | Structure | PO^{a} | EO^{b} | MW^{c} | gradability |
| IE 1 | (EDA)₁/(PO/NH)₆/ | 86.6 | 9.7 | 1636 | 53% (26 days) |
| | (EO/NH)₁ - block | | | | |
| IE 2 | (EDA)₁/(PO/NH)₁₀/ | 84.9 | 12.9 | 2736 | 60% (28 days) |
| | (EO/NH)₂ - random | | | | |
| IE 3 | (EDA)₁/(PO/NH)_{5.5}/ | 84.4 | 11.6 | 1514 | 46% (26 days) |
| | (EO/NH)₁ - block | | | | |
| IE 4 | (EDA)₁/(EO/NH)₂/ | 84.9 | 12.9 | 2736 | 71% (28 days) |
| | (PO/NH)₁₀- block | | | | |
| IE 5 | (EDA)₁/(PO/NH)₁₀/ | 84.9 | 12.9 | 2736 | 60% (28 days) |
| | (EO/NH)₂- block | | | | |
| CE A* | (EDA)₁/(PO/NH)_{2.5}/ | 53.7 | 40.7 | 1081 | 18% (26 days) |
| | (EO/NH)_{2.5} - block | | | | |
| CE B* | (EDA)₁/(PO/NH)₈/ | 59.0 | 39.1 | 3152 | 18% (28 days) |
| | (EO/NH)₇ - block | | | | |

^{a}propylene oxide content by weight % in relation to the total weight of the diamine alkoxylate
^{b}ethylene oxide content by weight % in relation to the total weight of the diamine alkoxylate
^{c}calculated molecular weight, based on the molar ratios of the starting materials

The following liquid hand dishwashing compositions were prepared by simple mixing. All the examples comprised the same level of surfactant and the same ratio of anionic surfactant to co-surfactant.

Inventive examples 1 to 4 comprised 2% by weight of a diamine alkoxylate of use in the 5 present invention. In contrast, comparative examples A and B comprised diamine alkoxylates (CE A and CE B, respectively) which had a propylene oxide content lower than that required by the present invention. Comparative example C did not comprise any diamine alkoxylate, and was used as the reference for the suds mileage assessment (index 100).

TABLE 2
Comparative and inventive liquid hand dishwashing detergent compositions.

| | Ex 1 | Ex 2 | Ex 3 | Ex 4 | Ex A* | Ex B* | Ex C* |
|---|---|---|---|---|---|---|---|
| Wt % (100% active basis) | wt % | wt % | wt % | wt % | wt % | wt % | wt % |
| C12-13 AE0.6S¹ | 15.36 | 15.36 | 15.36 | 15.36 | 15.36 | 15.36 | 15.36 |
| C12-14 dimethyl amine oxide | 5.91 | 5.91 | 5.91 | 5.91 | 5.91 | 5.91 | 5.91 |
| Diamine Alkoxylate IE 1 | 2.0 | — | — | — | — | — | — |
| Diamine Alkoxylate IE 2 | — | 2.0 | — | — | — | — | — |
| Diamine Alkoxylate IE 3 | — | — | 2.0 | — | — | — | — |
| Diamine Alkoxylate IE 4 | — | — | — | 2.0 | — | — | — |
| Diamine Alkoxylate CE A | — | — | — | — | 2.0 | — | — |
| Diamine Alkoxylate CE B² | — | — | — | — | — | 2.0 | — |
| NaCl | 0.5 | 0.5 | 0.5 | 0.5 | 0.5 | 0.5 | 0.5 |
| Na Cumene Sulphonate (NaCS) | 0.5 | 0.5 | 0.5 | 0.5 | 0.5 | 0.5 | 0.5 |
| Polypropylene glycol (MW 1000) | 0.4 | 0.4 | 0.4 | 0.4 | 0.4 | 0.4 | 0.4 |
| Ethanol | — | — | — | — | — | — | 1.22 |
| Proxel ® BIT preservative | 0.005 | 0.005 | 0.005 | 0.005 | 0.005 | 0.005 | 0.005 |
| Phenoxyethanol | 0.08 | 0.08 | 0.08 | 0.08 | 0.08 | 0.08 | 0.08 |
| Water and minors (dye, perfume) | bal. | bal. | bal. | bal. | bal. | bal. | bal. |
| pH (as a 10% solution in | 9 | 9 | 9 | 9 | 9 | 9 | 9 |
| demineralized water) | | | | | | | |
| Polymer biodegradibility | 53% | 60% | 46% | 71% | 18% | 18% | n.a. |
| Suds mileage index under greasy | 113 | 114 | 113 | 113 | 104 | 113 | ref |
| conditions 42° C., 1.25 mmol/l Ca | | | | | | | |
| equivalence (7 dH)⁺ | | | | | | | |

*Comparative
⁺after 26 days or 28 days, according to the methodology described herein
⁺⁺ Index vs. comparative example C
¹42.06% branching

From the experimental results, it can be seen that the diamine alkoxylates of use in the present invention have been found to be more readily biodegradeable, while also improving suds longevity under greasy conditions (inventive examples 1 to 4). The biodegradability is shown to be further improved through the use of diamine alkoxylate which comprise from 7 to 11 POs per alkoxylate branch and/or have a weight average molecular weight (Mw) of from 2,000 to 2,900 g/mol, more preferably in the range of from 2,500 to 2,800 g/mol (see examples IE 2, IE 4 and IE5 in table 1).

In contrast, the diamine alkoxylate used in comparative example A had a weight average molecular weight which was below that of diamine alkoxylates of use in the present invention, while the diamine alkoxylate used in comparative example B had a propylene oxide content below that of diamine alkoxylates of use in the present invention. In both cases, the resultant diamine alkoxylate had a substantially reduced biodegradability. Furthermore, as can be seen from comparative example A, reduced molecular weight of the diamine alkoxylate also gave rise to a substantial reduction in suds longevity in the presence of greasy soil.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid hand dishwashing detergent composition comprising:
a) from about 5% to about 50% by weight of the composition of a surfactant system, wherein the surfactant system comprises anionic surfactant; and
b) diamine alkoxylate, wherein:
i. at least one NH-functionality of a diamine used to form the diamine alkoxylate is modified to form a polyalkylene oxide branch;
ii. each polyalkylene oxide branch comprises ethylene oxide (EO) and propylene oxide (PO);
iii. a weight average molecular weight (Mw) of the diamine alkoxylate is in a range of from about 1,200 g/mol to about 3,200 g/mol; and
iv. a propylene oxide content is between about 65% and about 95% by weight of the diamine alkoxylate.

2. The liquid hand dishwashing detergent composition of claim 1, wherein the diamine used to form the diamine alkoxylate has two primary amine groups.

3. The liquid hand dishwashing detergent composition of claim 1, wherein each polyalkylene oxide branch comprises on average:
a) at least about 1 EO unit; and
b) at least about 5 PO units.

4. The liquid hand dishwashing detergent composition of claim 1, wherein each polyalkylene oxide branch comprises on average:
a) not more than about 5 EO units; and
b) not more than about 12 PO units.

5. The liquid hand dishwashing detergent composition of claim 1, wherein the propylene oxide content is between about 70% to about 95% by weight of the diamine alkoxylate.

6. The liquid hand dishwashing detergent composition of claim 1, wherein the diamine used to form the diamine alkoxylate has a molecular weight (Mw) ranging from about 50 g/mol to about 1500 g/mol.

7. The liquid hand dishwashing detergent composition of claim 1, wherein the weight average molecular weight (Mw) of the diamine alkoxylate is in a range of from about 1,500 g/mol to about 3,000 g/mol.

8. The liquid hand dishwashing detergent composition of claim 1, wherein the diamine used to form the diamine alkoxylate is selected from the group consisting of 1,2-diaminoethane (EDA), 1,3-diaminopropane, 2,2-dimethyl-1,3-diaminopropane, 1,4-diaminobutane, 1,5-diaminopentane, 1,6-diaminohexane, 1,7-diaminoheptane, 1,8-diaminooctane, cyclohexyl-diamine and methylcyclohexyl-diamine.

9. The liquid hand dishwashing detergent composition of claim 1, wherein each polyalkylene oxide branch comprises a block structure of ethylene oxide and propylene oxide.

10. The liquid hand dishwashing detergent composition of claim 9, wherein each polyalkylene oxide branch comprises a polyethylene oxide and polypropylene oxide block.

11. The liquid hand dishwashing detergent composition of claim 10, wherein each polyalkylene oxide branch comprises a polyethylene oxide and polypropylene oxide block and the diamine is first modified with the polypropylene oxide and secondly with the polyethylene oxide block.

12. The liquid hand dishwashing detergent composition of claim 1, wherein the diamine alkoxylate is present at a level of from about 0.05% to about 5.0% by weight of the composition.

13. The liquid hand dishwashing detergent composition of to claim 1, wherein the composition comprises from about 6.0% to about 40% by weight of the detergent composition of the surfactant system.

14. The liquid hand dishwashing detergent composition of claim 1, wherein the surfactant system comprises at least about 40% by weight of the surfactant system of the anionic surfactant.

15. The liquid hand dishwashing detergent composition of claim 14, wherein the anionic surfactant comprises at least about 70% by weight of the anionic surfactant of alkyl sulfated anionic surfactant, wherein the alkyl sulfated anionic surfactant has a number average alkyl chain length of from 8 to 18 carbon atoms.

16. The liquid hand dishwashing detergent composition of claim 15, wherein the alkyl sulfated anionic surfactant has an average degree of alkoxylation of less than about 3.5.

17. The liquid hand dishwashing detergent composition of claim 14, wherein the anionic surfactant comprises branched anionic surfactant, wherein the anionic surfactant has a weight average degree of branching of at least about 10%.

18. The liquid hand dishwashing detergent composition of claim 1, wherein the composition further comprises a co-surfactant selected from amphoteric surfactant, zwitterionic surfactant, and mixtures thereof, wherein the anionic surfactant and the amphoteric co-surfactant are present in a weight ratio of from about 1:1 to about 8:1.

19. The liquid hand dishwashing detergent composition of claim 1, wherein the composition further comprises a co-surfactant selected from amphoteric surfactant, zwitterionic surfactant, and mixtures thereof, wherein the anionic surfactant and the amphoteric co-surfactant are present in a weight ratio of from about 2:1 to about 5:1.

20. The liquid hand dishwashing detergent composition of claim 18, wherein the composition comprises a co-surfactant selected from amphoteric surfactant, wherein the amphoteric surfactant comprises amine oxide amphoteric co-surfactant.
